(19) United States
(12) Patent Application Publication
(10) Pub. No.: US 2010/0275853 A1
(43) Pub. Date: Nov. 4, 2010

(54) Pet Litter Receptacle

(75) Inventor: Troy Petersen, Rosemount, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: ROYAL PET INCORPORATED, Inver Grove Heights, MN (US)

(21) Appl. No.: 12/432,596

(22) Filed: Apr. 29, 2009

(51) Int. Cl. A01K 29/00

(52) U.S. Cl. 119/165

(57) ABSTRACT

A pet litter receptacle includes a first tray comprising a cavity defined by sidewalls and a bottom surface. The receptacle includes a first grate positioned within the cavity such that a top surface of the grate is positioned below a top edge of the cavity. A first fabric material is positioned on and covering the top surface of the grate and having a top surface of the fabric material positioned above the top edge of the cavity such that liquids pass through the fabric material and the grate and collect in the cavity and solids are retained on the top surface of the fabric material.

### FIELD OF THE INVENTION

The present invention relates to a pet litter receptacle. More particularly, the present invention relates to a receptacle that is utilized by a dog or other house pet for relieving himself or herself indoors.

### BACKGROUND OF THE INVENTION

Many domestic animals, such as dogs, spend much of their day indoors. Dogs are typically trained to go outside to relieve themselves. However, due to the time demands on a dog's owner and/or family, there are many instances when a dog must remain indoors without an opportunity to relieve himself or herself outside. While pet owners understand that a dog must urinate and defecate, typical methods and devices that are utilized to allow a dog to relieve himself or herself within a housing unit have not eliminated the unsanitary conditions associated with the dog urinating and defecating within the housing unit.

One method includes confining a dog to an area having a non-permeable floor, where the dog can urinate and defecate without damaging the rest of the living area. However, upon returning home, the dog owner must clean and sanitize the floor.

Another method includes training the dog to relieve himself or herself on a newspaper spread out on the floor. While the owner dispose of the newspaper once the owner returns home, the owner also may have to clean the underlying floor to remove any seepage through the newspaper.

Another alternative method includes training the dog to utilize a pan containing absorbent material such as cat litter for the dog to urinate and defecate within. However, the dog's paws tend to entrap absorbent material within the pads. In many instances, when the pet uses a litter box containing the absorbent material, some of the absorbent material is wedged between the pet's pads and as the pet moves around the living area, the pads spread apart releasing absorbent material in unwanted areas within the housing unit. The unwanted deposit of the absorbent material causes the owner to have to clean up the absorbent material that is spread throughout the housing unit.

### SUMMARY OF THE INVENTION

The present invention includes a pet litter receptacle having a tray with a plurality of side walls which form an internal cavity. A grate is positioned within the cavity such that a top surface of the grate is recessed below a top surface of the tray. Fabric, such as an artificial grass, can be placed on the grate, where the fabric extends above the top edge of the tray while the top portion of the sidewalls retains the fabric in a selected position.

### BRIEF DESCRIPTION OF THE DRAWINGS

FIG. 1 is a top view of the pet litter tray having a grid positioned within a cavity of the tray.

FIG. 2 is a top view of the pet litter tray having a fabric positioned on a top surface of the grid.

FIG. 3 is an exploded view of one half of the pet litter tray.

FIG. 4 is a perspective view of the pet litter tray having a fabric positioned on a top surface of the grid.

FIG. 5 is a perspective view of one half of the tray being utilized as a litter receptacle.

FIG. 6 is a bottom view of two tray halves adjacent each other.

FIG. 7 is a bottom perspective view of a grate.

FIG. 8 is a partial exploded view of two adjacent trays and a connector that connects the trays.

FIG. 9 is a partial perspective view of the connector connecting two adjacent trays.

### DETAILED DESCRIPTION OF ILLUSTRATIVE EMBODIMENTS

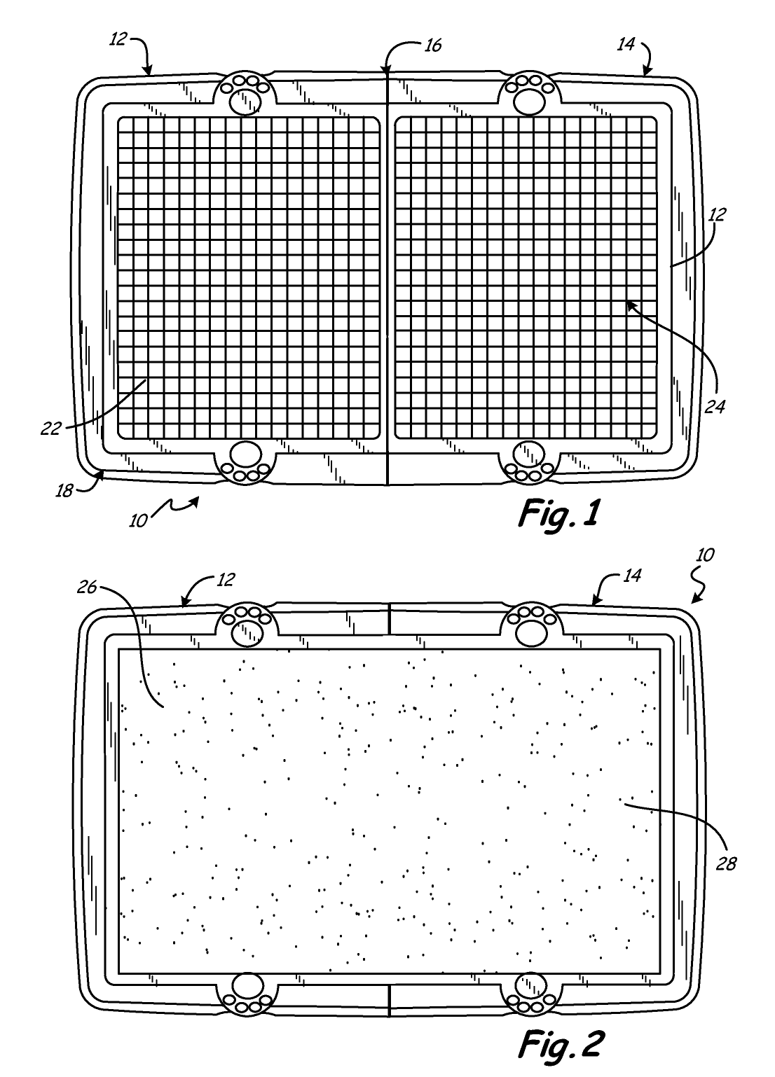

A pet litter receptacle is generally depicted at 10 in FIG. 1. The pet litter receptacle includes a left tray half 12 and a right tray half 14 that are joined together at a seam 16. The tray halves 12, 14 can also be used individually as pet litter receptacles.

Referring to FIGS. 1-3, the left and right tray halves 12, 14 are of a similar construction and both include a cavity 18 defined by sidewalls 20. The cavities 18 are sufficiently deep to retain left and right grates 22 and 24, respectively, therein. The grates 22, 24 are similarly constructed and include vertical and horizontal components 23, 25 that are positioned perpendicularly to each other, respectively, to form substantially square or rectangular openings that retain solid waste on an upper surface 27 while allowing liquid waste to pass through the grates 22, 24. However, other grid patterns are also contemplated.

The grates 22 and 24 can be covered with a fabric 26 such as artificial grass. The fabric 26 has sufficient porosity to allow urine or any other liquid to pass through the fabric where the liquid is retained within the cavity 18 while the solid waste is retained on top of the fabric 26.

The cavities 18 in left and right tray halves 12, 14 are each sized to accept a folded piece of newspaper or to accept an unfolded sheet of newspaper when the halves 12, 14 are joined together. Therefore, the trays 12, 14 allow the pet owner to utilize are readily available liquid absorbing material such as a newspaper within one tray 12 or 14 or both trays 12 or 14, by simply unfolding the newspaper or folding the newspaper. The cavity is typically about twelve inches by about twelve inches which accommodates most folded newspapers. However, other dimensions of the cavity are also contemplated. Alternatively, an absorbent pad or other absorbent material can also be positioned in the cavity 18 and below the grates 22 in the tray halves 12, 14.

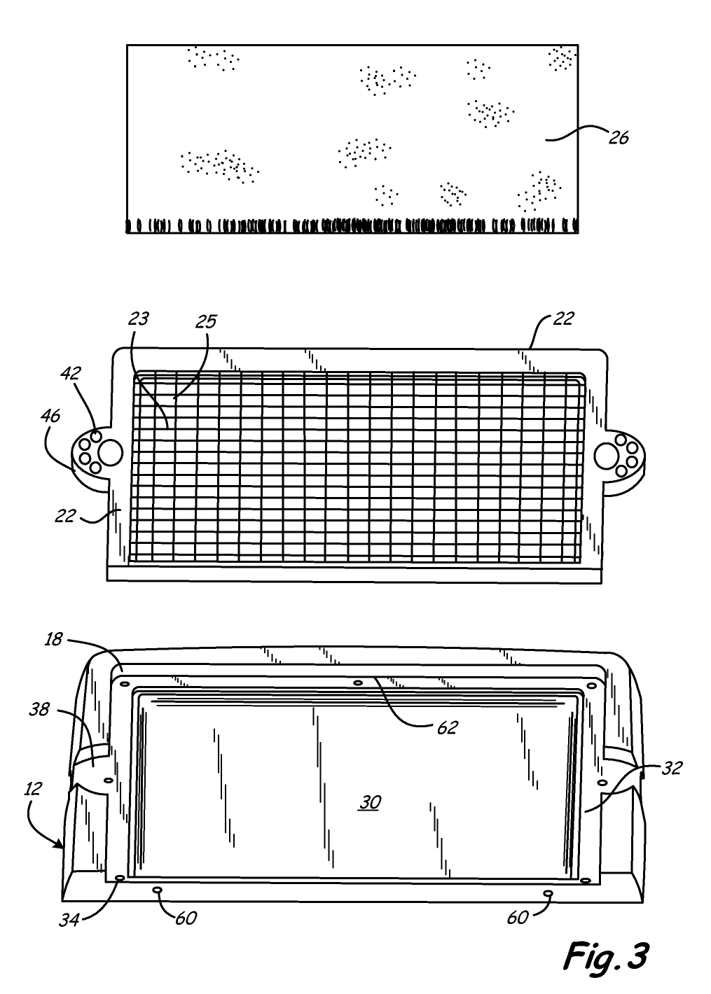

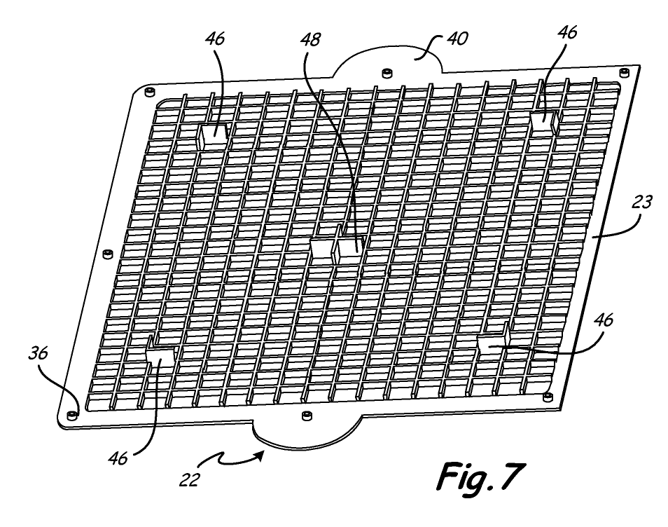

Referring to FIGS. 3 and 7, the perimeter of each cavity 30 includes a shoulder 32 upon which is engaged by an outer edge of the grate 22. The shoulder 32 includes apertures 34 which accept pegs 36 extending downwardly from a bottom surface 23 of the grate 22. By positioning the pegs 36 within the apertures 34, the grate 22 is non-slidably retained to the tray 12 such that lateral movement of the grate 22 is minimized.

The tray 12 includes cut out portions 38 that accept handle portions 40 of the grate. The handle portions 40 provide a gripping surface for easily removing the grate 22 from the tray 12 for removing solid waste on top of the tray 12 or fabric 26 and also to remove liquid waste from the cavity 18.

The handle portions 40 typically include a design or some other indicia 42 that enhance the appearance of the receptacle. However, the design or indicia 42 is not required.

The grate 22 includes a plurality of extensions 46 extending from the bottom surface 23 and proximate each of the corners of the grate 22. A substantially centrally located extension 48 is extended from the bottom surface 23 of the grate 22. Bottom surfaces of the extensions 46 and 48 contact a bottom surface of the cavity 18 such that the grate 22 is rigidly secured to the tray 12.

The extensions 46 and 48 provide rigidity to the grate 22 such that the weight of the dog, or other animal, does not cause bowing or bending of the grate 22 over time. The extensions 46, 48 also maintain the bottom surface 23 of the grate 22 a distance from the bottom of the cavity 18 such that urine or other liquid does not contact the bottom surface 23 such that the grate 22 does not have to be cleaned as frequently as a grate that contacts a bottom surface of the cavity.

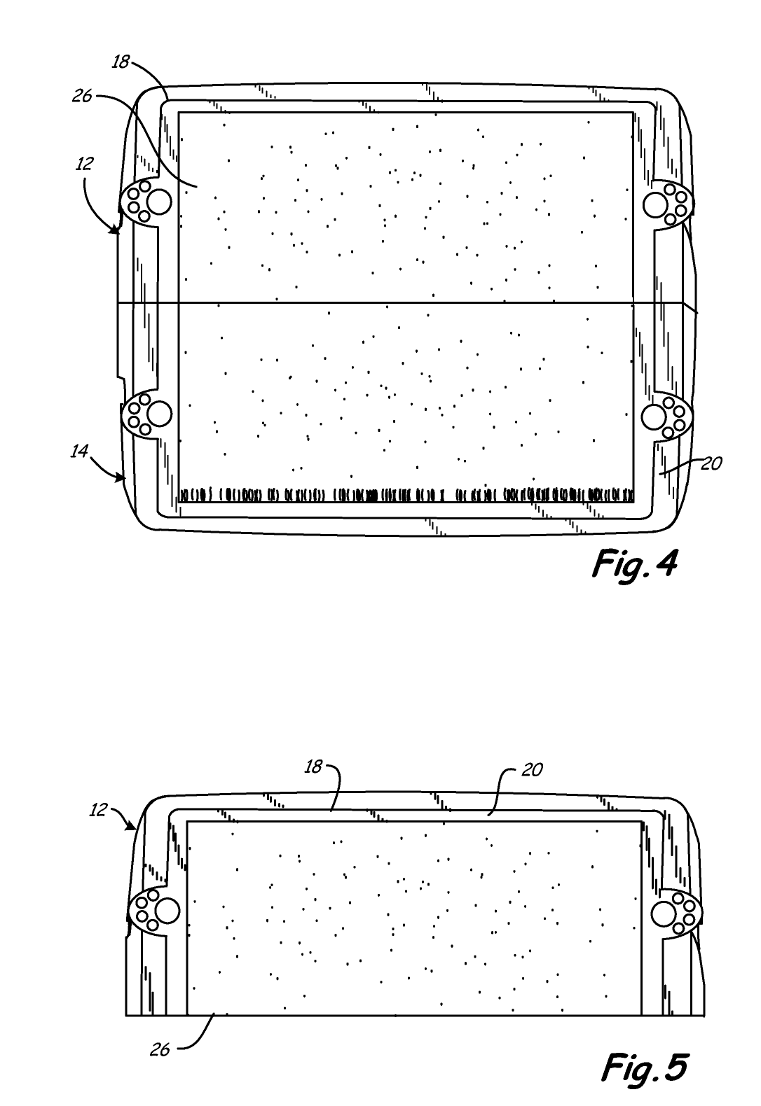

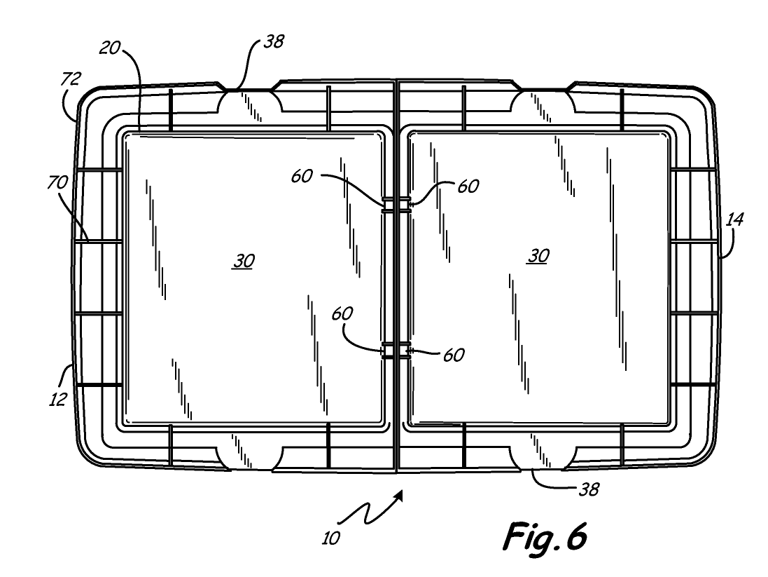

Referring to FIGS. 4 and 5, the tray halves 12, 14 can be connected together as shown in FIG. 4 or utilized as a single tray as shown in FIG. 5. The tray halves 12 and 14 are typically joined together for larger dogs, while a single tray 12 is adequate for smaller dogs. The tray halves 12, 14 are joined together typically by magnetic members 60 positioned along mating edges of the tray halves 12, 14.

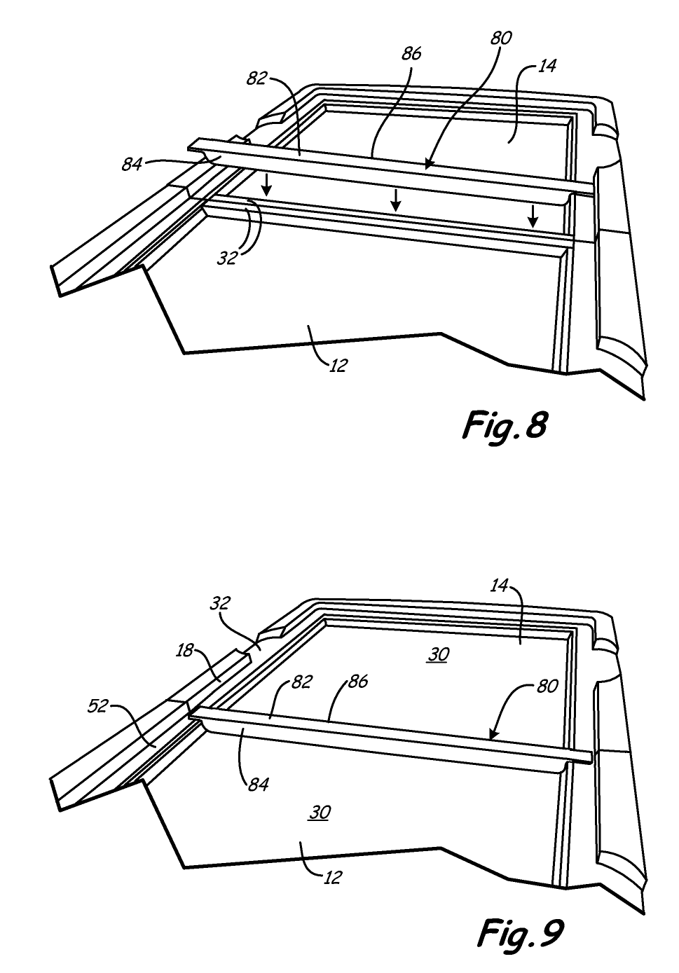

Referring to FIGS. 8 and 9 another connecting mechanism 80 for the tray halves 12, 14 is illustrated. The connecting mechanism 80 includes a top portion 82 that separates two side walls 84 and 86 that form a channel that is positioned over the seam between the two tray halves 12, 14. The top portion 82 extends to the upper portion 62 of the side wall 20 such that the entire seam is covered. The side walls 84 and 86 extend to the bottom surfaces 30. By covering the entire seam with the connecting mechanism 80, no urine or fecal matter is able to escape the litter tray 10 through the seam. However, other fastening mechanisms are also contemplated.

The side walls 20 of the tray halves 12, 14 typically include a lower portion 60 which is about the length of the extensions 46, 48 extending from the grate 22. The side walls also includes an upper portion 62 having a top end 64 that extends above the top end 13 of the tray halves 12 and also such that a top portion 62 which engages the fabric 26. With the fabric 26 engaging the top portion 62, the fabric 26 is retained in position and does not slide when the dog steps onto the tray 10 or steps off of the tray 10.

The tray halves 12 and 14 are typically constructed from a polymeric material through a molding process such that each half 12 and 14 is of a unitary or monolithic structure. The tray halves include ribs 70 between the outer rim 72 and the sidewalls 20 to provide rigidity to the tray halves 12 and 14. The grate 22 is also typically constructed from a polymeric material through a molding process such that each grate is also of a unitary or monolithic structure.

Although the present invention has been described with reference to preferred embodiments, workers skilled in the art will recognize that changes may be made in form and detail without departing from the spirit and scope of the invention.

1. A pet litter receptacle comprising:
a first tray comprising a cavity defined by sidewalls and a bottom surface;
a first grate positioned within the cavity such that a top surface of the grate is positioned below a top edge of the cavity; and
a first fabric material positioned on and covering the top surface of the grate and having a top surface of the fabric material positioned above the top edge of the cavity such that liquids pass through the fabric material and the grate and collect in the cavity and solids are retained on the top surface of the fabric material.

2. The pet litter receptacle of claim 1 and wherein at least one of the sidewalls of the first tray comprises:
a bottom portion;
a top portion; and
a shoulder joining the bottom portion and the top portion wherein an edge of the grate abuts the shoulder.

3. The pet litter receptacle of claim 1 and wherein the shoulder comprises at least one aperture.

4. The pet litter receptacle of claim 3 and wherein at least one peg extends from a bottom surface of the first grate and wherein the at least one peg positions within the at least one aperture to non-slidably secure the first grate within the cavity.

5. The pet litter receptacle of claim 1 and wherein the first tray further comprises at least one cut out portion in at least one of the sidewalls.

6. The pet litter receptacle of claim 5 and wherein the first grate comprises a handle extending from a perimeter of the grate and wherein the handle positions through the cut out portion and an end of the handle extends beyond the perimeter of the first tray.

7. The pet litter receptacle of claim 1 and wherein the first grate comprises a plurality of extension extending from the bottom surface thereof and wherein bottom edges of the plurality of extensions engage the bottom surface of the cavity such that the bottom surface of the first grate is a distance apart from the bottom surface of the cavity.

8. The pet litter receptacle of claim 7 and wherein the plurality of extensions comprises a plurality of extensions positioned proximate the perimeter of the first grate and at least one extension substantially centrally positioned on the first grate.

9. The pet litter receptacle of claim 1 and wherein the first tray comprises a connecting mechanism located proximate an edge of the perimeter.

10. The pet litter receptacle of claim 9 and wherein the connecting mechanism comprises a magnetic connector.

11. The pet litter receptacle of claim 1 and further comprising an absorbent material positioned between the bottom surface of the cavity and the first grate.

12. The pet litter receptacle of claim 11 and wherein the absorbent material comprises a newspaper.

13. The pet litter receptacle of claim 1 and further comprising:
a second tray comprising a cavity defined by sidewalls and a bottom surface;
a second grate positioned within the cavity such that a top surface of the grate is positioned below a top edge of the cavity; and
a second fabric material positioned on and covering the top surface of the grate and having a top surface of the fabric material positioned above the top edge of the cavity such that liquids pass through the fabric material and the grate and collect in the cavity and solids are retained on the top surface of the fabric material wherein an edge of the second tray is positioned adjacent an edge of the first tray to form the pet litter receptacle.

14. The pet litter receptacle of claim 1 and further comprising:
a second tray comprising a cavity defined by sidewalls and a bottom surface;
a second grate positioned within the cavity such that a top surface of the grate is positioned below a top edge of the cavity;
a second fabric material positioned on and covering the top surface of the grate and having a top surface of the fabric material positioned above the top edge of the cavity such that liquids pass through the fabric material and the grate and collect in the cavity and solids are retained on the top surface of the fabric material; and
a connector comprising a top portion and spaced apart first and second side walls that form a channel, wherein the connector is positioned about a seam between the first and second trays to prevent leakage from the pet litter receptacle through the seam between the first and second trays.

15. The pet litter receptacle of claim 13 and wherein at least one of the sidewalls of the second tray comprises:
a bottom portion;
a top portion; and
a shoulder joining the bottom portion and the top portion wherein an edge of the grate abuts the shoulder.

16. The pet litter receptacle of claim 13 and wherein the shoulder comprises at least one aperture.

17. The pet litter receptacle of claim 16 and wherein at least one peg extends from a bottom surface of the second grate and wherein the at least one peg positions within the at least one aperture to non-slidably secure the second grate within the cavity.

18. The pet litter receptacle of claim 13 and wherein the second tray further comprises at least one cut out portion in at least one of the sidewalls.

19. The pet litter receptacle of claim 18 and wherein the second grate comprises a handle extending from a perimeter of the secondgrate and wherein the handle positions through the cut out portion and an end of the handle extends beyond the perimeter of the second tray.

20. The pet litter receptacle of claim 13 and wherein the second grate comprises a plurality of extension extending from the bottom surface thereof and wherein bottom edges of the plurality of extensions engage the bottom surface of the cavity such that the bottom surface of the second grate is a distance apart from the bottom surface of the cavity.
